(19) United States
(12) Patent Application Publication
(10) Pub. No.: US 2013/0076525 A1
(43) Pub. Date: Mar. 28, 2013

(54) SYSTEM AND METHOD FOR REMOTE WELL MONITORING

(71) Applicants: George Hoang Vu, Magnolia, TX (US); Thomas Lee Hitt, Katy, TX (US); Wilbert J. Chenevert, Cypress, TX (US); Brett Bibby, Houston, TX (US)

(72) Inventors: George Hoang Vu, Magnolia, TX (US); Thomas Lee Hitt, Katy, TX (US); Wilbert J. Chenevert, Cypress, TX (US); Brett Bibby, Houston, TX (US)

(21) Appl. No.: 13/703,307

(22) PCT Filed: Jun. 10, 2010
(86) PCT No.: PCT/US10/38193

§ 371 Date: Dec. 10, 2012

(51) Int. Cl. G01V 3/34

(52) U.S. Cl. CPC G01V 3/34
USPC 340/853.1

(57) ABSTRACT

Systems and methods for remote monitoring of a wellsite operation may include receiving login information from a user and displaying a wellsite listing. The user may select at least one wellsite and may provide input regarding at least one parameter of interest for the at least one wellsite. A server may receive data regarding the at least one wellsite via a transceiver from a sensor disposed at a wellsite measuring the at least one parameter of interest. The data regarding the at least one parameter of interest may be transmitted as a dashboard after creation and rendering of teh dashboard at a server. The dashboard may be displayed via a wellsite information display module on a personal mobile device. The display of the at least one parameter of interest is customizable by the user or administrator of the system.

### FIELD OF THE INVENTION

The present disclosure relates generally to the field of telemetry systems for transmitting information through a flowing fluid. More particularly, the disclosure relates to the field of signal detection in such a system.

### BACKGROUND OF INVENTION

Drilling and home office personnel are being asked to remotely monitor multiple wells at a time. While online, real time monitoring is available in the office/home environment. The continuous nature of the drilling operational process makes remote well monitoring using personal mobile devices desirable, and would allow substantially continuous access to wellsite data.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention.

FIG. 1 is a network diagram of an example system for monitoring wellsite data.

FIG. 2 illustrates an example mobile system that may be used for acquiring and monitoring wellsite data.

FIG. 3 shows the architecture of one example of a personal mobile device.

FIG. 4 shows an example of a wellsite drilling system.

FIG. 5A shows an example of a wellsite wireline logging system.

FIG. 5B shows an example of a wellsite completion system.

FIG. 6 shows an example of a wellsite production system.

FIG. 7 shows another example of a system for remote monitoring and control of a wellsite system.

FIG. 8 is an example flow diagram for monitoring of wellsite data.

FIG. 9 illustrates an example graphical user interface (GUI) on a personal mobile device (PMD) for user login.

FIG. 10 illustrates an example GUI screenshot on a PMD with a well listing.

FIG. 11 illustrates an example GUI screenshot on a PMD with a parameter display.

FIG. 12 illustrates an example GUI screenshot on a PMD with a dashboard listing.

FIG. 13 illustrates an example GUI screenshot on a PMD with a dashboard.

FIG. 14 illustrates an example GUI screenshot on a PMD with a send command.

FIG. 15 shows one example of a flow chart for one embodiment of a method according to the present disclosure.

### DETAILED DESCRIPTION OF AN EMBODIMENT OF THE INVENTION

With reference to the attached figures, certain embodiments of the present invention include a system 100 that may include a network 102 that couples together at least one personal mobile device (PMD) 106A-106N to at least one wellsite 104A-104N. The wellsites 104A-104N may include an information handling systems (IHS) 33A-33N that may collect, process, store, and display various wellsite data and real time operating parameters. For example, the IHS 33 may receive wellsite data from various sensors at the wellsite, including downhole and surface sensors, as described below. Network 102 may include multiple communication networks working in conjunction with multiple servers.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for scientific, control, or other purposes.

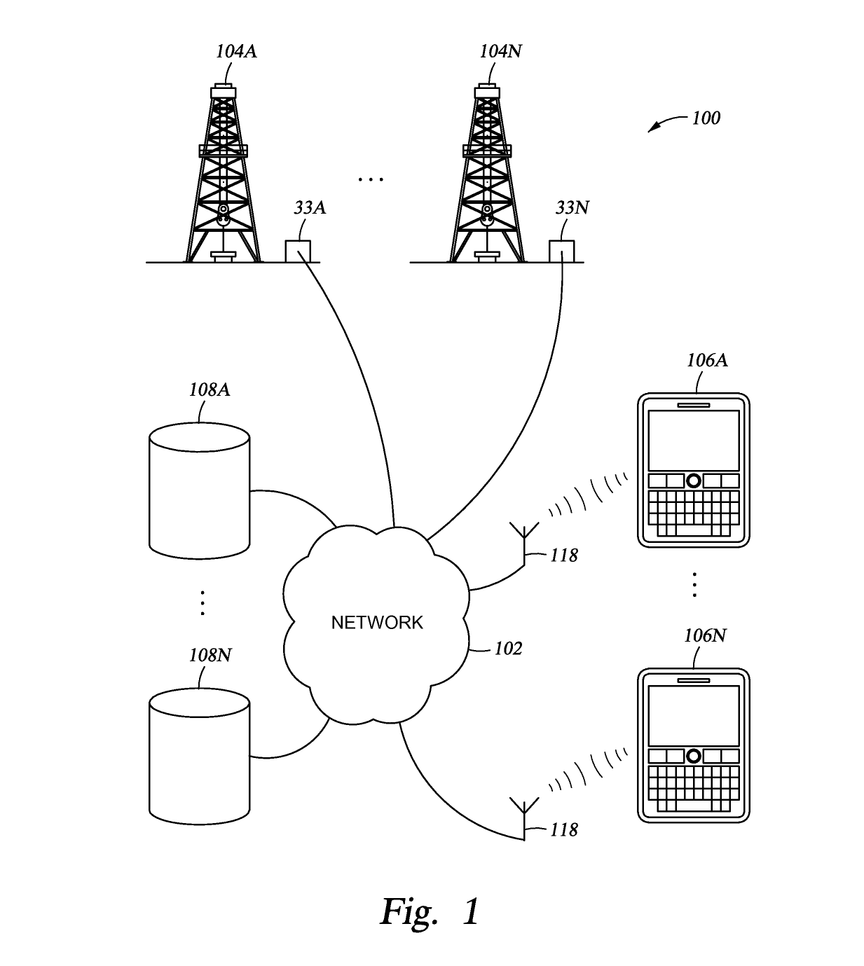

The wellsite data may be replicated at one or more remote locations relative to the wellsite. For example, IHS 33 may transmit the wellsite data to one or more non volatile machine-readable media 108A-108N. In addition IHS 33 may transmit data via network 102 and radio frequency transceivers 118 to PMDs 106A-N. In some embodiments, the non-volatile machine readable media 108A-108N may be representative of servers for storing the wellsite data therein. The network communication may be any combination of wired and wireless communication. In one example, at least a portion of the communication is transferred across the internet using TCP/IP internet protocol. In some embodiments, the network communication may be based on one or more communication protocols (e.g., HyperText Transfer Protocol (HTTP), HTTP Secured (HTTPS), Application Data Interface (ADI), Well Information Transfer Standard Markup Language (WITSML), etc.). A particular non-volatile machine-readable medium 108 may store data from one or more wellsites and may be stored and retrieved based on various communication protocols. The non-volatile machine-readable media 108 may include disparate data sources (such as ADI, Javi Application Data Interface (JADI), Well Information Transfer Standard Markup Language (WISTML), Log ASCII Standard (LAS), Log Information Standard (LIS), Digital Log Interchange Standard (DLIS), Well Information Transfer Standard (WITS), American Standard Code for Information Interchange (ASCII), OpenWorks, SiesWorks, Petrel, Engineers Data Model (EDM), Real Time Data (RTD), Profibus, Modbus, OLE Process Control (OPC), various RF wireless communication protocols (such as Code Division Multiple Access (CDMA), Global System for Mobile Communications (GSM), etc.), Video/Audio, chat, etc.). While the system 100 shown in FIG. 1 employs a client-server architecture, embodiments are not limited to such an architecture, and could equally well find application in a distributed, or peer-to-peer, architecture system.

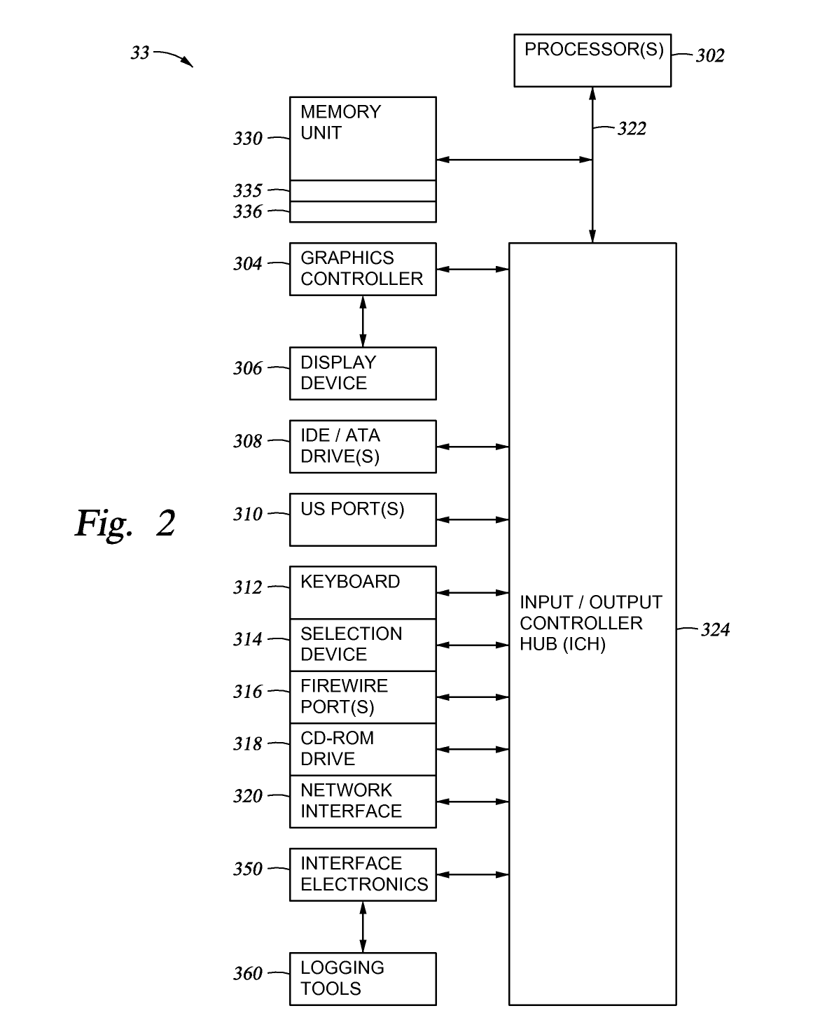

FIG. 2 illustrates an information handling systems (IHS) 33 that may be used for acquiring and monitoring wellsite data, according to some embodiments. In the example shown, the IHS 33 may include one or more processors 302. The IHS 33 may also include a memory unit 330, processor bus 322, and an input/output controller hub (ICH) 324. The processor(s) 302, memory unit 330, and ICH 324 may be coupled to the processor bus 322. The processor(s) 302 may include any suitable processor architecture. IHS 33 may include one or more processors, any of which may execute a set of instructions in accordance with embodiments of the invention.

The memory unit 330 may store data and/or instructions, and may include any suitable memory, such as a dynamic random access memory (DRAM). IHS 33 may also include hard drives such as IDE/ATA drive(s) 308 and/or other suitable computer readable media storage and retrieval devices. A graphics controller 304 may control the display of information on a display device 306, according to certain embodiments of the invention.

The input/output controller hub (ICH) 324 may provide an interface to I/O devices or peripheral components for IHS 33. The ICH 324 may include any suitable interface controller to provide for any suitable communication link to the processor(s) 302, memory unit 330 and/or to any suitable device or component in communication with the ICH 324. In certain embodiments of the invention, the ICH 324 may provide suitable arbitration and buffering for each interface. In certain embodiments, a wellsite monitoring application 335 and a mobile wellsite monitoring application 336 may be stored in memory unit 330. Mobile wellsite monitoring application 336 may interface with wellsite monitoring application 335 and may enable PMD 106 to access, over network 102, the data collected and processed by wellsite monitoring application 335.

ICH 324 may also interface with downhole logging tools 360 (described below), through interface electronics 350. Interface electronics 350 may also contain analog and/or digital circuitry to at least receive signals from logging tools 360, convert them to data suitable for input to processor 302. Such circuits are known to those skilled in the art, and are not described in detail here.

For some embodiments of the invention, the ICH 324 may provide an interface to one or more suitable integrated drive electronics (IDE) drives 308, such as a hard disk drive (HDD) or compact disc read only memory (CD ROM) drive, or to suitable universal serial bus (USB) devices through one or more USB ports 310. In certain embodiments, the ICH 324 may also provide an interface to a keyboard 312, a mouse 314, a CD-ROM drive 318, one or more suitable devices through one or more firewire ports 316. For certain embodiments of the invention, the ICH 324 may also provide a network interface 320 though which IHS 33 can communicate with other computers and/or devices.

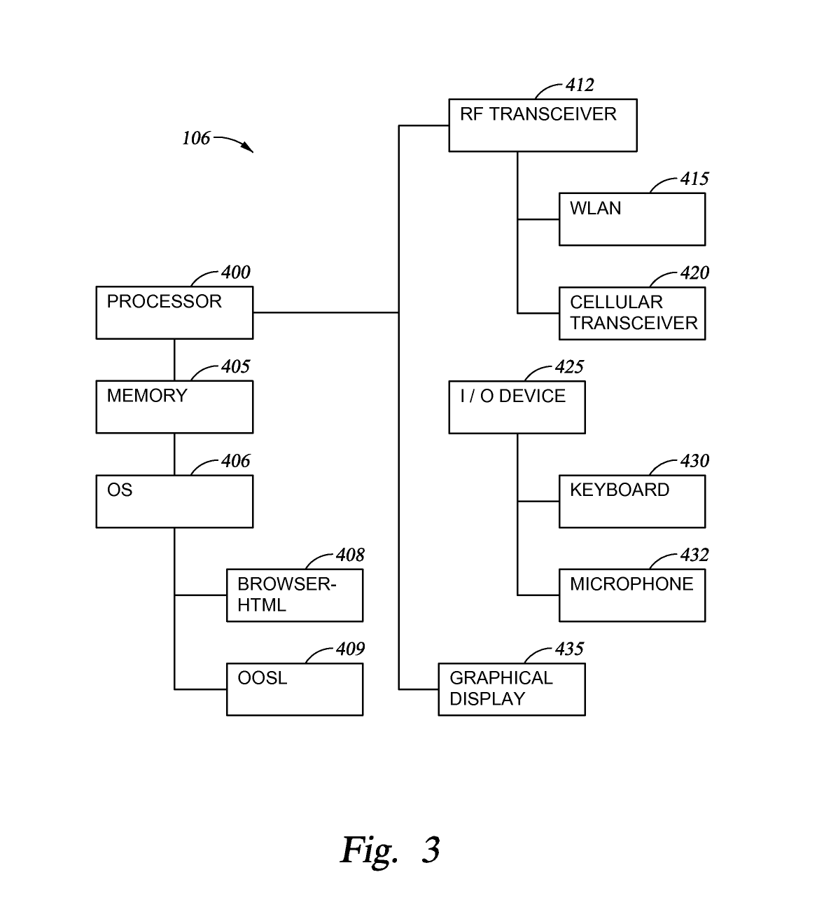

FIG. 3 shows the architecture of one example of a portable mobile device (PMD) 106. As shown, PMD 106 may include a processor 400 in data communication with a memory 405 suitable for storing an operating system (OS) 406. Processor 400 may be connected by an interface bus 410 to various components including: a radio frequency transceiver 412 that may include a wireless local area network (WLAN) transceiver 415; a cellular transceiver 420; or both. Other components may include an input/output device 425; and a graphical display 435. In certain examples, WLAN transceiver 415 is a WiFi device. Cellular transceiver 420 may transmit and receive signals in any suitable cellular protocol including, but not limited to CDMA and GSM.

Input/output device 425 may include a keyboard 430. Keyboard 430 may include physical keys, or alternatively, keyboard 430 may be implemented as a touch screen keyboard. Input/output device 425 may also include a microphone for inputting voice commands using voice recognition applications known in the art. In one example, graphic display 435 includes a suitable graphic display having a pixel resolution of at least 160 by 160 pixels. In certain embodiments, PMD 106 weighs no more than about one pound. In certain examples, OS 406 may be able to run an Internet/intranet web browser 408 enabling HTML. In certain examples, OS 406 may also be able to run an object oriented scripting language (OOSL) 409, for example the Javascript brand object oriented scripting language developed by Sun Microsystems, Inc.

In one embodiment, PMD 106 described above may include a smartphone. Such a smartphone may include, but are not limited to: the Iphone by Apple Inc.; various Blackberry models by Research in Motion, Inc.; the Palm Treo by Palm Inc.; Droid by Motorola, Inc.; and any other suitable smartphone now known or developed in the future that has the characteristics described above. Each of the phones described above has a suitable OS for executing the actions and instructions described above. Embodiments of the present invention may allow for consistent look and feel across various devices.

Alternatively, PMD 106 may include a personal digital assistant (PDA) device. PDA's have many of the functional attributes of the smartphone described but may not have voice communication commonly associated with the smartphone. Examples include, but are not limited to, Apple's IPOD Touch brand and Hewlett Packard's IPAQ brand of PDA's. In addition, any satellite phone having the characteristics described herein may be used.

The application may be installed on the device operating system and may run independently of any other device applications.

Described below are operational examples of wellsite systems, for example, a drilling and logging system, and a production system, where data may be acquired, processed, and transmitted over the Internet/intranet to such a PMD as described above.

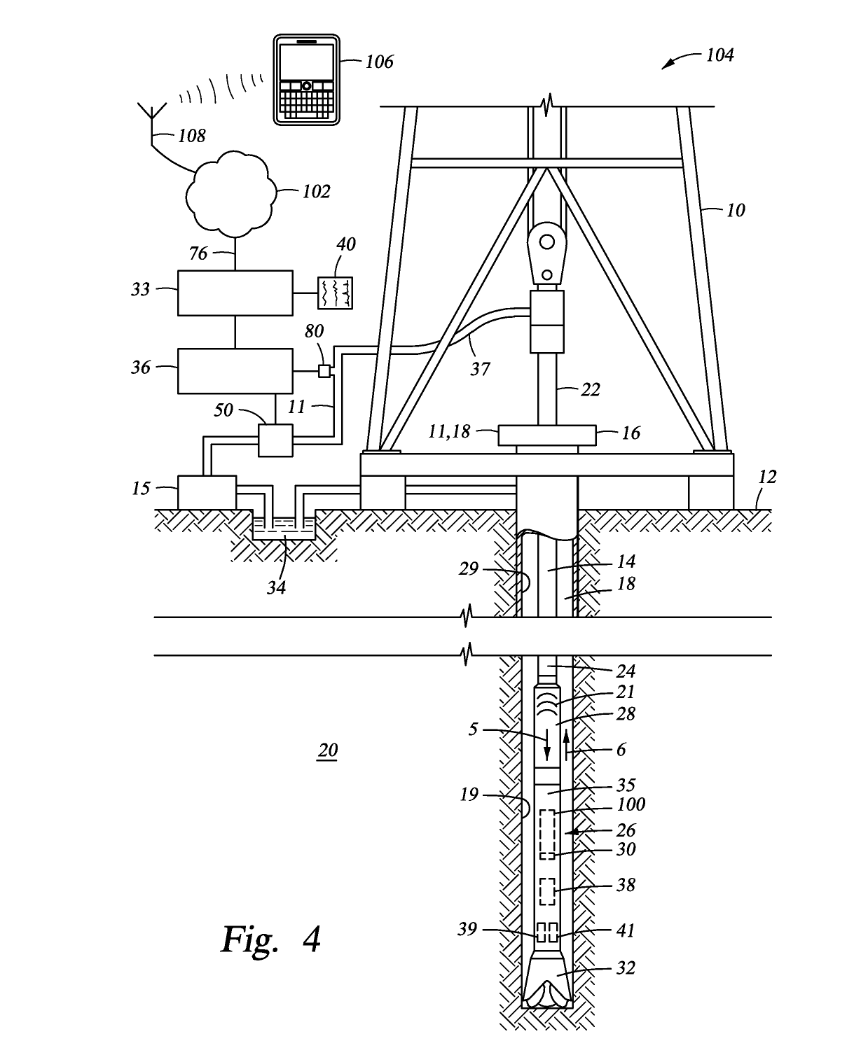

Referring to FIG. 4, a drilling system 104 is illustrated which may include a drilling derrick 10, constructed at the surface 12 of the well, supporting a drill string 14. The drill string 14 may extend through a rotary table 16 and into a borehole 18 that is being drilled through earth formations 20. The drill string 14 may include a kelly 22 at its upper end, drill pipe 24 coupled to the kelly 22, and a bottom hole assembly 26 (BHA) coupled to the lower end of the drill pipe 24. The BHA 26 may include drill collars 28, an MWD tool 30, and a drill bit 32 for penetrating through earth formations to create the borehole 18. In operation, the kelly 22, the drill pipe 24 and the BHA 26 may be rotated by the rotary table 16. Alternatively, or in addition to the rotation of the drill pipe 24 by the rotary table 16, the BHA 26 may also be rotated, as will be understood by one skilled in the art, by a downhole motor (not shown). The drill collars may add weight to the drill bit 32 and stiffen the BHA 26, thereby enabling the BHA 26 to transmit weight to the drill bit 32 without buckling. The weight applied through the drill collars to the bit 32 may permit the drill bit to crush the underground formations.

As shown in FIG. 4, BHA 26 may include an MWD tool 30, which may be part of the drill collar section 28. As the drill bit 32 operates, drilling fluid (commonly referred to as “drilling mud”) may be pumped from a mud pit 34 at the surface by pump 15 through standpipe 11 and kelly hose 37, through drill string 14, indicated by arrow 5, to the drill bit 32. The drilling mud may be discharged from the drill bit 32 and functions to cool and lubricate the drill bit, and to carry away earth cuttings made by the bit. After flowing through the drill bit 32, the drilling fluid may flow back to the surface, indicated by arrow 6, through the annular area between the drill string 14 and the borehole wall 19, or casing wall 29. At the surface, it may be collected and returned to the mud pit 34 for filtering. In one example, the circulating column of drilling mud flowing through the drill string may also function as a medium for transmitting pressure signals 21 carrying information from the MWD tool 30 to the surface.

MWD tool 30 may include sensors 39 and 41, which may be coupled to appropriate data encoding circuitry, such as an encoder 38, which sequentially produces encoded digital data electrical signals representative of the measurements obtained by sensors 39 and 41. While two sensors are shown, one skilled in the art will understand that a smaller or larger number of sensors may be used without departing from the scope of the present invention. The sensors 39 and 41 may be selected to measure downhole parameters including, but not limited to, environmental parameters, directional drilling parameters, and formation evaluation parameters. Such parameters may include downhole pressure, downhole temperature, the resistivity or conductivity of the drilling mud and earth formations, the density and porosity of the earth formations, as well as the orientation of the wellbore. Sensor examples include, but are not limited to: a resistivity sensor, a nuclear porosity sensor, a nuclear density sensor, a magnetic resonance sensor, and a directional sensor package. In addition, formation fluid samples and/or core samples may be extracted from the formation using formation tester. Such sensors and tools are known to those skilled in the art.

In one example, data representing sensor measurements of the parameters discussed above may be generated and stored in the MWD tool 30. Some or all of the data may be transmitted by data signaling unit 35, through the drilling fluid in drill string 14. A pressure signal traveling in the column of drilling fluid may be detected at the surface by a signal detector unit 36 employing a pressure detector 80 in fluid communication with the drilling fluid. The detected signal may be decoded in IHS 33. In one embodiment, a downhole data signaling unit 35 is provided as part of MWD tool 30. Data signaling unit 35 may include a pressure signal transmitter 100 for generating the pressure signals transmitted to the surface. The pressure signals may include encoded digital representations of measurement data indicative of the downhole drilling parameters and formation characteristics measured by sensors 39 and 41. Alternatively, other types of telemetry signals may be used for transmitting data from downhole to the surface. These include, but are not limited to, electromagnetic waves through the earth and acoustic signals using the drill string as a transmission medium. In yet another alternative, drill string 14 may include wired pipe enabling electric and/or optical signals to be transmitted between downhole and the surface. In one example, IHS 33 may be located proximate the rig floor. Alternatively, IHS 33 may be located away from the rig floor. In certain embodiments, IHS 33 may be incorporated as part of a logging unit. In certain embodiments, a surface transmitter 50 may transmit commands and information from the surface to the downhole MWD/LWD system. For example, surface transmitter 50 may generate pressure pulses into the flow line that propagate down the fluid in drill string 14, and may be detected by pressure sensors in MWD tool 30. The information and commands may be used, for example, to request additional downhole measurements, to change directional target parameters, to request additional formation samples, and to change downhole operating parameters.

In addition to downhole measurements, various surface parameters may be measured using sensors 17, 18 located at the surface. Such parameters may include rotary torque, rotary RPM, well depth, hook load, standpipe pressure, and any other suitable parameter of interest.

The surface and downhole parameters may be processed by IHS 33 using software for the operation and management of drilling, completion, production, and servicing of onshore and offshore oil and gas wells, for example the Insite® brand of software owned by Halliburton, Inc. In one embodiment, the software produces data that may be presented to the driller and operational personnel in a variety of visual display presentations, for example, on display 40. Alternatively, any suitable processing application package may be used.

The processed information may be transmitted by IHS 33 via communication link 76 to network 102 that couples one or more wellsites to one or more PMDs 106 via a radio frequency transceiver 108, for example, a cellular link, a WiFi link, and a satellite link. In one embodiment, PMD 106 may be used to transmit commands back to IHS 33, via the RF and network path. Such commands may be used, for example, to request additional downhole measurements, to change directional target parameters, to request additional formation samples, and to change downhole operating parameters.

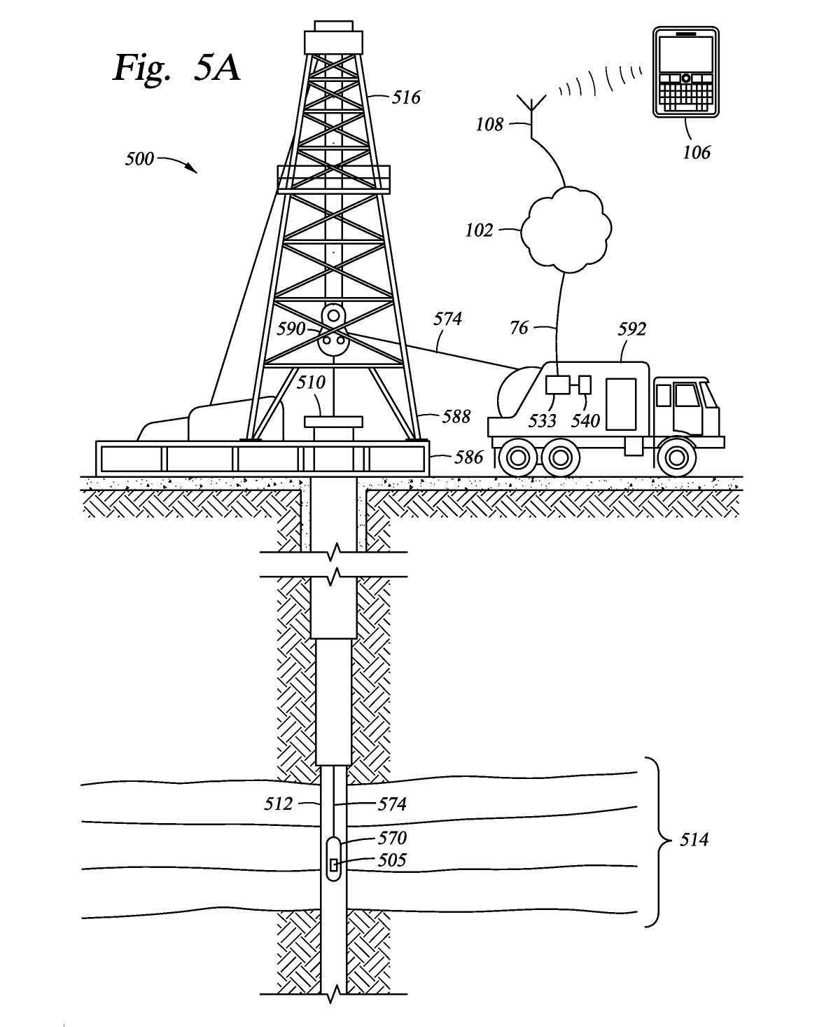

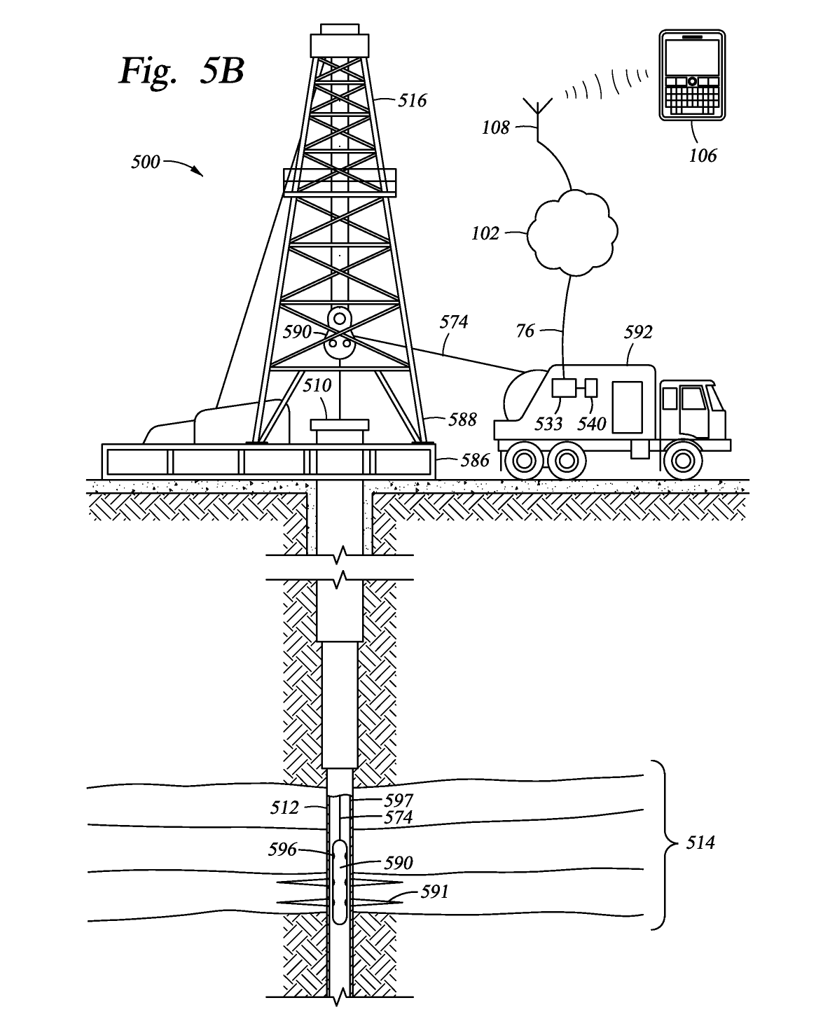

FIG. 5A illustrates an example of a wireline logging system 500. A derrick 516 may support a pulley 590. Drilling of oil and gas wells is commonly carried out by a string of drill pipes connected together so as to form a drilling string that is lowered through a rotary table 510 into a wellbore or borehole 512. Here it is assumed that the drilling string has been temporarily removed from the borehole 512 to allow a wireline logging tool 570, such as a probe or sonde, to be lowered by wireline or logging cable 574 into the borehole 512. The wireline logging cable 574 may have one or more electrical and/or optical conductors for communicating power and signals between the surface and the logging tool 570. Typically, the tool 570 is lowered to the bottom of the region of interest and subsequently pulled upward. During the upward trip, sensors 505 located in the tool 570 may be used to perform measurements on the subsurface formations 514 adjacent the borehole 512 as they pass. Measurements may include those described above with respect to MWD/LWD operations.

The measurement data can be communicated to an IHS 533 in logging unit 592 for storage, processing, and analysis. The logging facility 592 may be provided with electronic equipment for various types of signal processing. Similar log data may be gathered and analyzed during drilling operations (e.g., during Logging While Drilling, or LWD operations). The log data may also be displayed at the rig site for use in the drilling and/or completion operation on display 540. In one example, measured wellsite data may be processed by a wellsite monitoring application resident in IHS 533 as described above. The processed information may be transmitted by IHS 533 via communication link 76 to network 102 that couples one or more wellsites to one or more PMDs 106 via a radio frequency transceiver 108, for example, a cellular link or a WiFi link. In certain embodiments, PMD 106 may be used to transmit commands back to IHS 533, via the RF and network path. Such commands may include, for example, requests for additional downhole measurements, changes in measurement parameters, and requests for additional formation samples.

FIG. 5B shows an example wireline completion system using deployment equipment similar to that of FIG. 5A. In this example, a perforating tool 590 is connected to wireline 574 and is deployed in casing 597. Perforating tool 590 may have electronic circuits for interfacing with surface IHS 533. In addition, perforating tool 590 may have sensors (not shown) for detecting each casing joint so that the location of the perforating tool 590 may be accurately determined at the surface. Perorating tool includes shaped explosive charges 596 that may be triggered from the surface to create perforations 591 through casing 597 and into formation 514. Such penetrations provide a flow path for fluids in the formation to the production tubing. In certain examples, information, for example the location of the perforating tool 590 and the logging information for the formation 514 proximate the perforating tool may be transmitted by IHS 533 via communication link 76 to network 102 that couples one or more wellsites to one or more PMDs 106 via a radio frequency transceiver 108, for example, a cellular link or a WiFi link. In one embodiment, PMD 106 may be used to transmit commands back to IHS 533, via the RF and network path. Such commands may include, for example, commands to perforate at an indicated downhole location.

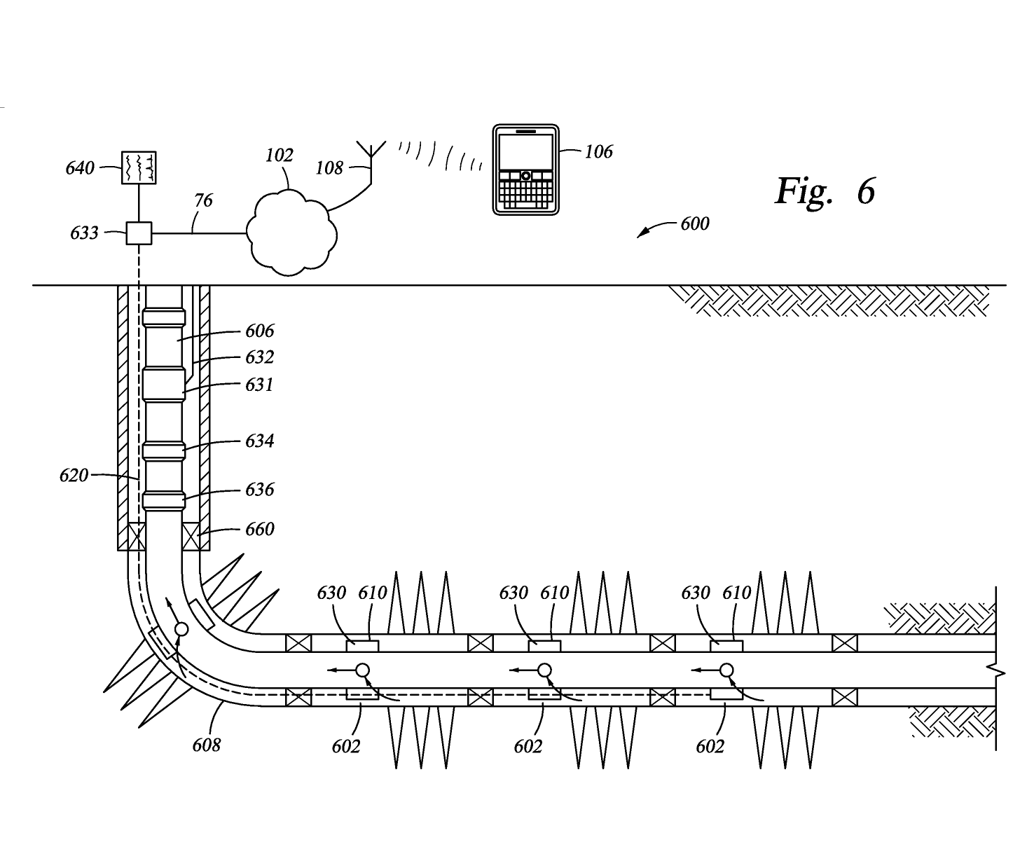

FIG. 6 shows an example of a production well system 600. A production tubing string 606 is disposed in a well 608. One or more interval control valves 610 may be disposed in tubing string 606 and provide an annulus to tubing flow path 602. Sensors 630 may be incorporated in interval control valves 610 detecting reservoir data. Interval control valve 610 may include a choking device that isolate the reservoir from the production tubing 606. It will be understood by those skilled in the art that there may be an interrelationship between one control valve and another. For example, as one valve is directed to open, another control valve may be directed to close. A production packer 660 provides a tubing-to-casing seal and pressure barrier, isolates zones and/or laterals from the well bore 608 and allows passage of an electro-hydraulic umbilical 620. Packer 660 may be a hydraulically set packer that may be set using the system data communications and hydraulic power components. The system may also include other components well known in the industry including safety valve 631, control line 632, gas lift device 634, and disconnect device 636. It will be understood by those skilled in the art that the well bore may be cased partially having an open hole completion or may be cased entirely.

A surface IHS 633 may act according to programmed instructions to operate the downhole interval control valves 610 in response to sensed reservoir parameters. In one example, measured reservoir data may be processed by a wellsite production monitoring application resident in IHS 633. The processed information may be transmitted by IHS 633 via communication link 76 to network 102 that couples one or more wellsites to one or more PMDs 106 via a radio frequency transceiver 108, for example, a cellular link or a WiFi link In one embodiment, PMD 106 may be used to transmit commands back to IHS 633, via the RF and network path. Such commands may include, for example, requests for additional reservoir measurements, and commands to open or close various interval control valves 610. In one embodiment, data from multiple wells in a production field may be processed and transmitted.

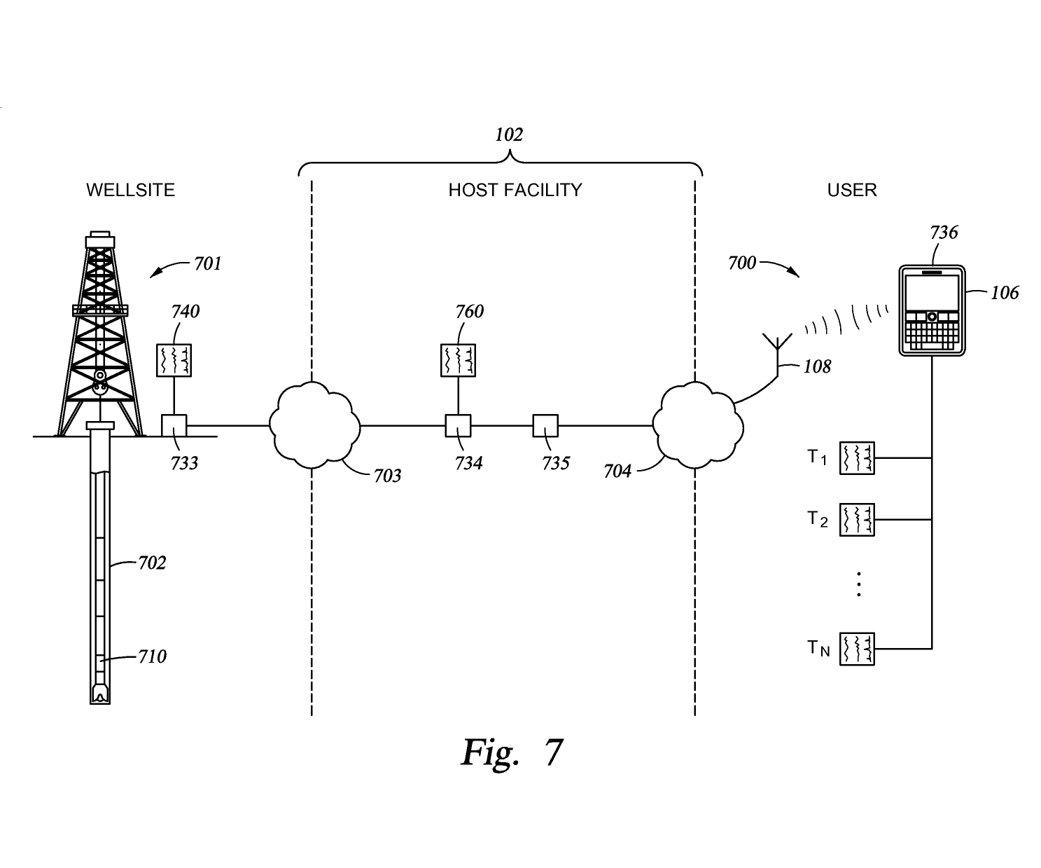

FIG. 7 shows an example of a system 700 for remote monitoring and control of a wellsite system. Well system 701 may be at least one of drilling system, a logging system, a completion system, a production system and combinations thereof, as previously described. IHS 733 may acquire downhole measurement data from sensors 710 in well 702. IHS 733 may process this data as described previously using an application program resident in IHS 733. In certain examples, IHS 733 may display portions of the data on display 740.

In certain examples, the processed data/one or more parameters of interest may be transmitted using a suitable protocol across a network 703 to IHS 734 at a host facility. Network 703 may be an intranet, the Internet, or a combination thereof. IHS 734 may have additional application programs resident therein to further process the wellsite data and display information on display 760. IHS 734 may be in data communication with IHS 735. IHS 735 may act as a network server.

Alternatively, data may be transferred directly from IHS 733 to a PMD 106 or from IHS 734 to the PMD 106. Data may be transferred via network 703 and/or network 704. In certain embodiments, the data may be captured and transmitted, on demand, over network 704, and via an RF link 108 to a user's PMD 106. An application module 736 operating on the PMD 106 and stored in a memory of the PMD 106 may process the data.

A dashboard generation program may provide predetermined format dashboards, T1-Tn, that present at least portions of the data from wellsite 701 in a suitable visual format, also called a virtual terminal that further facilitates client interpretation of wellsite status. Dashboards may include, but are not limited to, graphical images or files. Dashboards may be created on IHS 735 or other servers. Dashboards may be customizable by a user. Many parameters may be collected by the monitoring system, and a user may select some or all of the features for display. Different parameters of interest may be displayed for different projects. A user may use menu selection features to customize and/or view the parameters of interest. Dashboards may not be required for all embodiments.

Predetermined formats and options may be stored with the program data. Dashboards may include screenshots of at least one operational and/or logging process. As used herein, a screenshot is an image of the visible items set forth on a display, for example the data shown on displays 740 and 760. In certain examples, the data is presented in substantially real time (allowing for network transmission delays). Dashboards may be customizable by a user choosing which information is displayed and in what format. By packaging these options in an application on the PMD 106, control is retained over how information is presented to a user on a given system. A user would also have the ability to view dashboards generated by a back end system. Dashboards may be continuously updated based upon incoming well monitoring information at a server, such as IHS 735. Dashboards may be sent to the PMD 106 based on requests from the PMD 106 to the server. In certain embodiments, the PMD 106 may be set to automatically update the dashboards by sending requests at certain predetermined intervals or based on other factors.

Data files may be pushed to the PMD 106 over the networks 703, 704. Rendering of the data may be accomplished through methods known to one skilled in the art. Data is best rendered natively on the device rather than through a browser interface; however, a browser interface could be used in certain embodiments. Therefore, while images may be pushed to the device, textual data may be rendered on the PMD 106. The user may select one or more parameters of interest to view or may call for more processing of the data for further or future analysis.

In addition, predetermined commands, as described previously, may be returned from PMD 106 across the system 700 to effect changes in operation at wellsite 701. This may allow a user the ability to control/intervene at a wellsite from a remote location. For example, a user may enter commands, such as “close valve” at the PMD 106 that is then manually or automatically actuated at the wellsite. This may improve automation and reduce manpower requirements at the wellsite.

The system may take advantage of various features of the PMD 106, such as the shake feature of an iPhone, to perform certain actions or to begin preparations for an onsite visit, such as the GPS function inherent in the PMD 106.

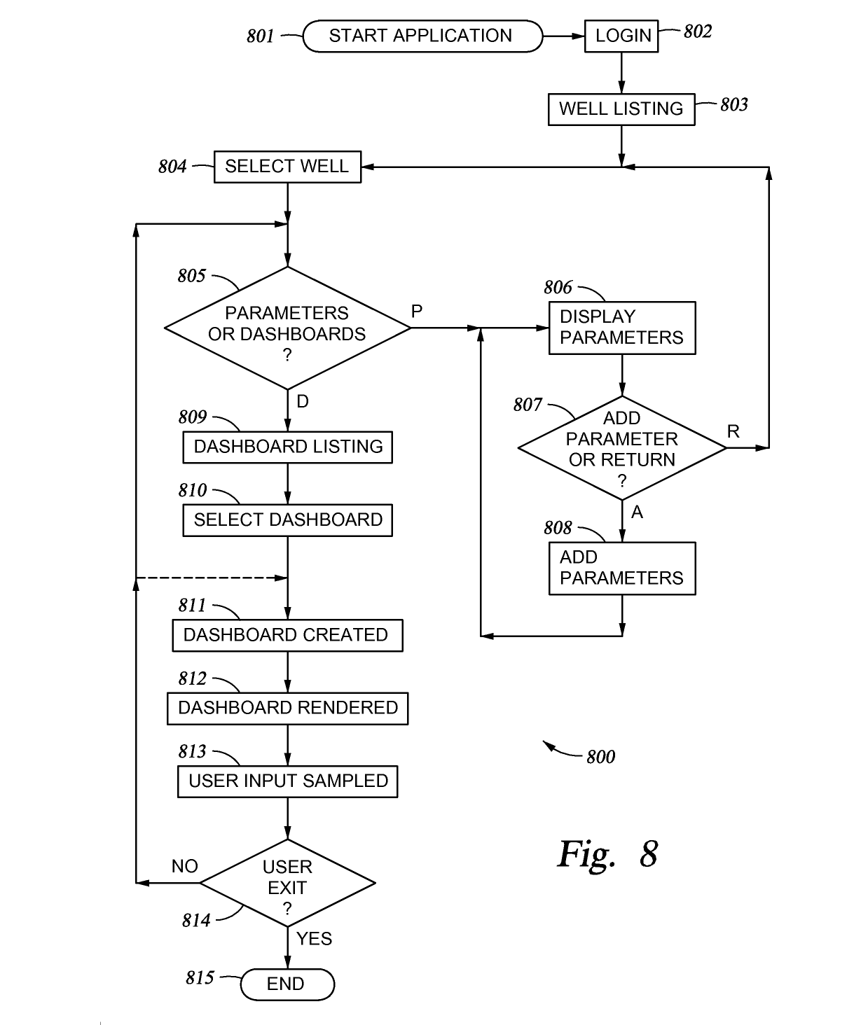

FIG. 8 is a flow diagram for monitoring of wellsite data, according to certain embodiments. The flow diagram 800 is described with reference to the system of FIG. 7. The flow diagram commences at block 801. At block 801, the user invokes the application system on PMD 106, in some embodiments this may include an application interface.

At block 802, a user login may be provided. At block 803, a user may be presented with a well or project listing, which may or may not be specific to the user. At block 804, the user may select a well or project of interest.

For each well or project, the user may be given an option to select parameters of dashboards 805. If parameters are selected, a predetermined set of parameters may be displayed 806. In certain embodiments, the parameters are a default set of parameters. A user may be given the option 807 to add a parameter or return to well or project selection. Parameters may be added 808 to the display if selected by the user.

If the user selects dashboards as an option, the user is presented with a listing of dashboards 809. The system may then receive an input 810 regarding the dashboard. The server/backend may then create a dashboard 811. The server/backend may then render the dashboard 812 as requested by the user and push the rendered dashboard to the PMD 106.

At block 813, user input devices may be sampled, the resulting values may then be conveyed to the application. These user inputs may include commands that are forwarded to the IHS at the well site being monitored and in turn may be forwarded to either surface or downhole equipment. The user input may be evaluated to determine if it is a local application command or a command intended to be forwarded to the wellsite. If the command is a wellsite destined command it is forwarded to the IHS at the well site being monitored, via a communication protocol. The communication protocol may forward the command to IHS 735. IHS 735 may forward the command to IHS 734, which may in turn forwarded the command to the wellsite IHS 733 for and either surface or downhole equipment. Other forwarding sequences may be possible.

At block 814, execution may continue if the user selects something other than exit of the application. The user may return to the parameters or dashboards decision 805, selection of a dashboard 810 or any other option presented through a menu or other type of selection process. If the user selects exit, execution continues at block 815. At any time during the process, the user may exit the system, check for updates, or perform other options available through menu selection processes.

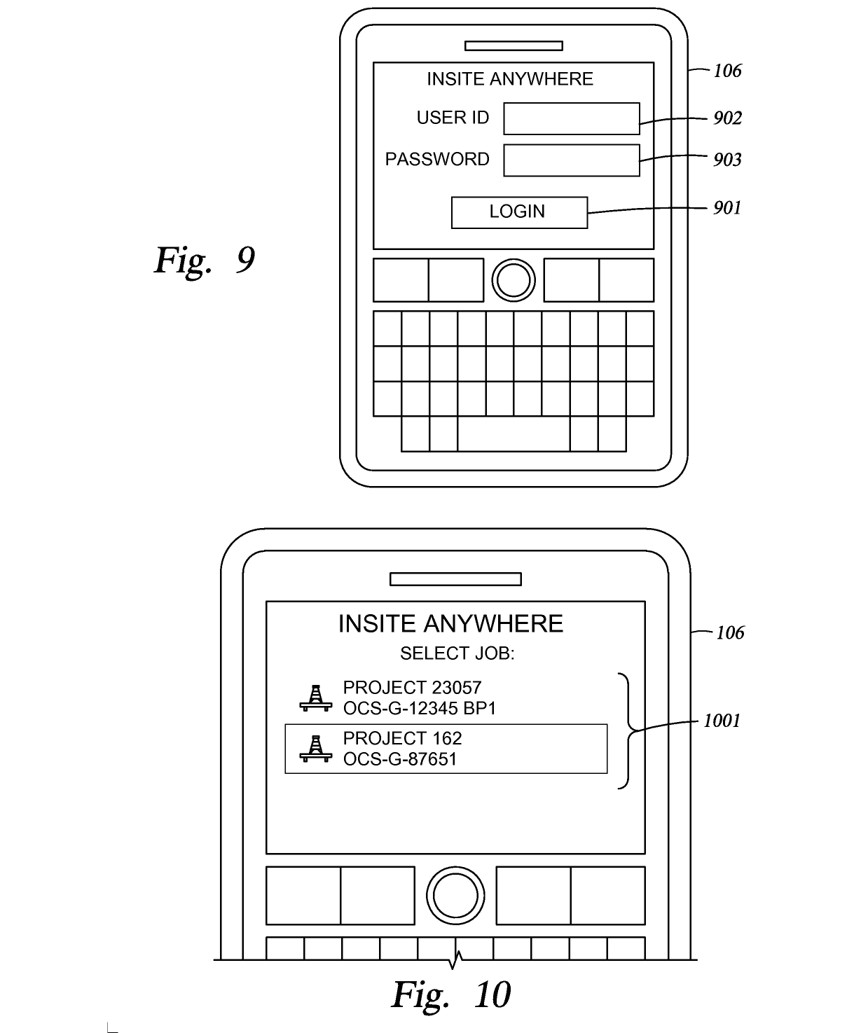

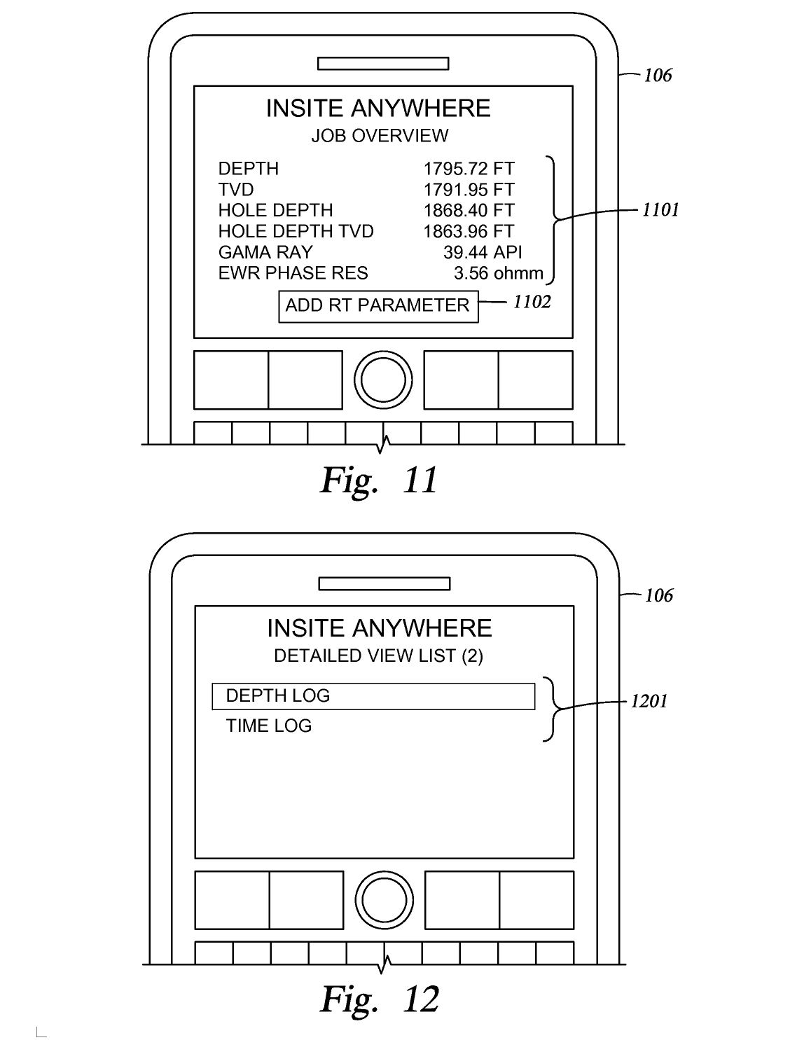

FIGS. 9-13 show different GUI screenshots for monitoring wellsite data on a PMD 106. FIG. 9 illustrates an example GUI screenshot on PMD 106 for user login 901, including a user identification 902 and/or password 903. FIG. 10 illustrates a GUI screenshot showing a well listing 1001 of jobs available to the user. FIG. 11 illustrates a GUI screenshot showing a parameter display and job overview 1101 with various parameters, such as depth, TVD, hole depth, hole depth TVD, gamma ray, and EWR phase resistance. An option to add a parameter 1102 is also shown that may allow for customization of the information presented.

FIG. 12 illustrates a GUI screenshot of dashboard listing 1201 with, for example, depth log and time log. An interactive menu may allow the user to select updates of the operational dashboard data using a manual refresh button or by selecting an automatic refresh at predetermined time intervals. The images on the display page may be updated without updating the rest of the content of the page. Black and white and/or color features may be added to the screens to indicate out of range parameters.

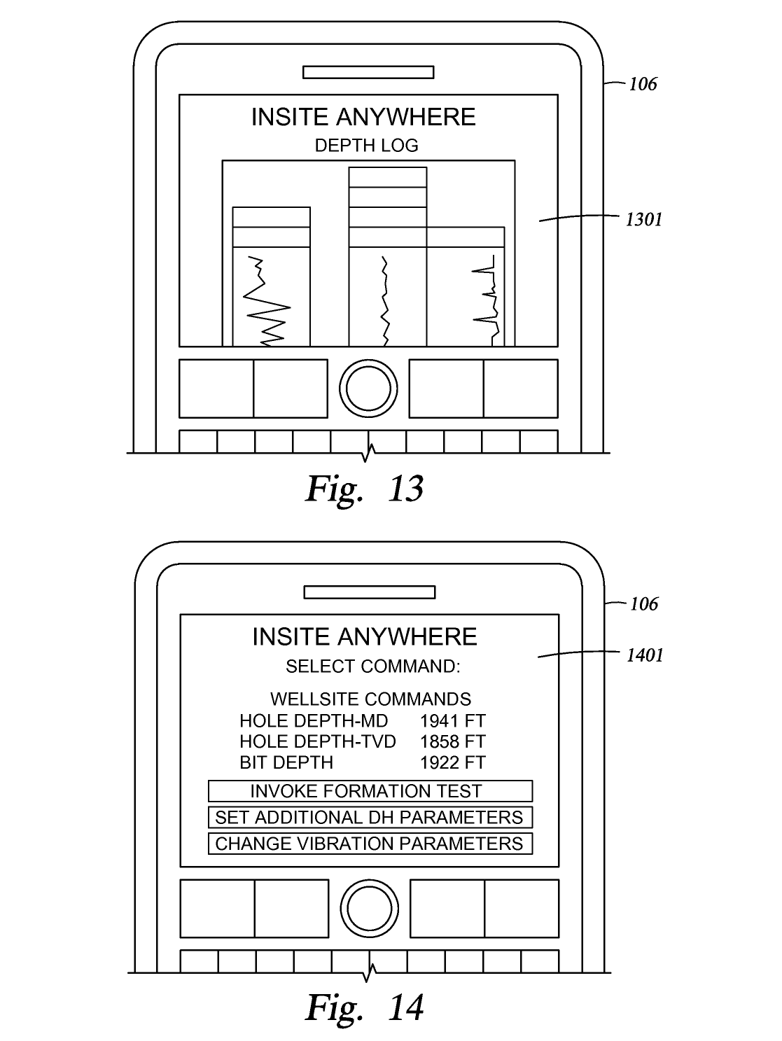

FIG. 13 illustrates a GUI screenshot of a dashboard 1301 displayed on PMD 106. PMD 106 may also be used to input changes to well site parameters. For example, changes in alarm ranges, directional targets, weight on bit, etc. may be dictated by remote evaluation of the data viewed on PMD 106.

FIG. 14 illustrates a GUI screenshot of a send command screen 1401 displayed on PMD 106. The commands displayed may be examples of the commands discussed above and may be invoked and transmitted back to the wellsite via the network 102 for execution at the wellsite. As illustrated, exemplary commands may include invoking a formation test, setting additional down hole parameters, and/or changing vibration parameters.

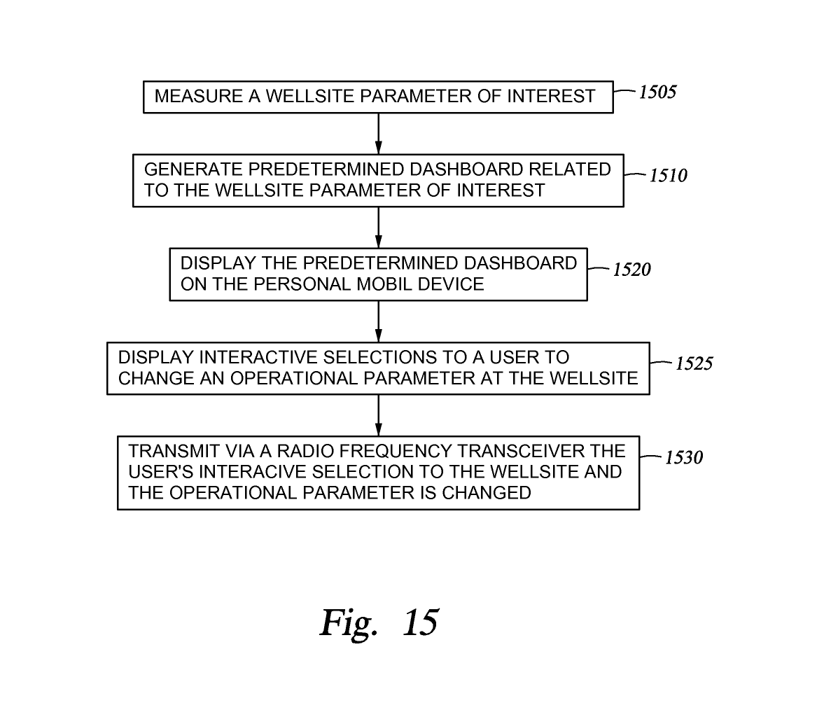

FIG. 15 shows one example of a flow chart for one embodiment of a method according to the present disclosure. In logic box 1505, a wellsite parameter of interest is measured. In logic box 1510, a dashboard related to the parameter of interest is generated. In logic box 1520, the predetermined dashboard is displayed on the personal mobile device. In logic box 1525, interactive selections are displayed on the personal mobile device to a user. In logic box 1530, the user's interactive selections are transmitted via a radio frequency transceiver to the wellsite and the operational parameter is changed.

The methods described above may also be embodied as a set of instructions on a computer readable medium including ROM, RAM, CD ROM, DVD, FLASH or any other computer readable medium, now known or unknown, that when executed causes a computer such as, for example, a processor in IHS 33, 533, 633, 733, 734, 735 to implement the methods of the present invention.

The discussion above has been primarily directed to the drilling and logging operation. One skilled in the art will appreciate that similar data review and control will also be advantageous to production systems, for example, as described in FIG. 6.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A system for remote monitoring of a wellsite operation, the system comprising:
at least one processor;
at least one memory;
the at least one processor executing the steps comprising:
receiving login information;
displaying a wellsite listing;
receiving a selection of at least one wellsite;
receiving user input regarding at least one parameter of interest for the at least one wellsite;
receiving data regarding the at least one wellsite via a transceiver from a sensor disposed at a wellsite measuring the at least one parameter of interest from a wellsite operation, wherein the data regarding the at least one parameter of interest is transmitted as a dashboard, based on the user input regarding the at least one parameter of interest, after creation and rendering of the dashboard at a server;
storing the data in the at least one memory; and
displaying the dashboard via a wellsite information display module on a personal mobile device, wherein the display of the at least one parameter of interest is customizable by the user or administrator of the system.

2. The system of claim 1, wherein the data passes through an information handling system in data communication with the sensor prior to reaching the personal mobile device.

3. The system of claim 1, wherein more than one parameter of interest are displayed simultaneously.

4. The system of claim 1, wherein the wellsite operation is chosen from the group consisting of: a drilling operation, a logging operation, a completion operation, and a production operation.

5. The system of claim 1, further comprising a transceiver, wherein the transceiver comprises at least one of a cellular phone transceiver, a WiFi transceiver, and a satellite phone transceiver.

6. The system of claim 1, further comprising transmitting information from the portable mobile device to the wellsite.

7. The system of claim 6, wherein the transmitting information comprises transmitting command operations for actuating an activity at the wellsite.

8. The system of claim 1, wherein the personal mobile device is at least one of a smartphone, a personal digital assistant, and a satellite phone.

9. The system of claim 1, wherein software is installed on a personal mobile device operating system and runs independently of other device applications.

10. A method of remotely monitoring a wellsite operation, the method comprising:
receiving, at a server, a measurement of one or more wellsite parameters of interest from a wellsite;
receiving, at the server, a request for a dashboard comprising at least one of the one or more wellsite parameters of interest from a personal mobile device;
creating, at the server, a dashboard based upon user input regarding a desired formatting and display of the one or more wellsite parameters of interest;
rendering, at the server, the dashboard; and
transmitting, by the server, the dashboard to the personal mobile device for displaying the dashboard on the personal mobile device.

11. The method of claim 10, wherein a menu selection on the personal mobile device allows a user to interactively select the formatting and display of the one or more wellsite parameters of interest.

12. The method of claim 10, further comprising receiving commands from the personal mobile device to change an operational parameter at the wellsite.

13. The method of claim 12, further comprising transmitting the commands to the wellsite for actuating an activity at the wellsite.

14. The method of claim 10, wherein the personal mobile device is at least one of a smartphone, a personal digital assistant, and a satellite phone.

15. The method of claim 10, wherein software is installed on a personal mobile device operating system and runs independently of other device applications.

16. A computer readable medium containing a set of instructions that when executed by an information handling system causes the information handling system to perform a method comprising:
receiving login information;
displaying a wellsite listing;
receiving a selection of at least one wellsite;
receiving user input regarding at least one parameter of interest for the at least one wellsite;
receiving data regarding the at least one wellsite via a transceiver from a sensor disposed at a wellsite measuring the at least one parameter of interest from a wellsite operation, wherein the data regarding the at least one parameter of interest is transmitted as a dashboard, based on the user input regarding the at least one parameter of interest, after creation and rendering of the dashboard at a server; and
displaying the dashboard via a wellsite information display module on a personal mobile device, wherein the display of the at least one parameter of interest is customizable by the user or administrator of the system.

17. The computer readable medium of claim 16, further comprising displaying a selection menu on the personal mobile device for a user to interactively select from at least one predetermined display.

18. The computer readable medium of claim 16, further comprising displaying interactive selections to allow a user to transmit a change in an operational parameter to the wellsite.

19. The computer readable medium of claim 18, further comprising transmitting commands to the wellsite for actuating an activity at the wellsite.

20. The computer readable medium of claim 16, wherein software is installed on a personal mobile device operating system and runs independently of other device applications.
